(19) United States
(12) Patent Application Publication
(10) Pub. No.: US 2025/0306565 A1
(43) Pub. Date: Oct. 2, 2025

(54) METHODS AND APPARATUS TO GENERATE PROCESS DIAGRAMS IN PROCESS CONTROL SYSTEMS

(71) Applicant: FISHER-ROSEMOUNT SYSTEMS, INC., Round Rock, TX (US)

(72) Inventors: Sujeet Nilkanth Deshpande, Shivajinagar (IN); Laxman Rangnath Jadhao, Shivajinagar (IN); Yatin Sudhir Dixit, Shivajinagar (IN)

(21) Appl. No.: 19/081,920

(22) Filed: Mar. 17, 2025

(30) Foreign Application Priority Data
Mar. 29, 2024 (IN) 202421026247

(51) Int. Cl. G05B 19/4097

(52) U.S. Cl. CPC G05B 19/4097; G05B 2219/35134

(57) ABSTRACT

Methods and apparatus to generate process diagrams in process control systems are disclosed. An example apparatus comprises interface circuitry, first machine-readable instructions, and at least one processor circuit to be programmed by the first machine-readable instructions to access input data that indicates a relationship between components in a diagram, the diagram graphically representing at least a portion of a process control system, determine coordinate locations associated with the input data within the diagram, and generate second machine-readable instructions including information corresponding to the coordinate locations, the second machine-readable instructions to cause a change to the diagram based on the input data, the changed diagram indicating the relationship between the components.

### FIELD OF THE DISCLOSURE

This disclosure relates generally to process control systems and, more particularly, to methods and apparatus to generate process diagrams in process control systems.

### BACKGROUND

Process control systems, like those used in chemical, oil refining or other processes, typically include one or more process controllers or devices communicatively coupled to an operator workstation and one or more field devices. These controllers can receive signals indicative of process measurements made by the field devices and generate control signals based on those measurements. Information from the field devices and the controllers may be made available to one or more user interface applications and visually presented to a user via diagrams presented on a user interface of an operator workstation.

### BRIEF DESCRIPTION OF THE DRAWINGS

FIG. 1 is a block diagram of an example environment in which example diagram manager circuitry operates to generate process control diagrams that represent a process control system.

FIGS. 2A and 2B illustrate example process control diagrams generated in accordance with teachings disclosed herein.

FIG. 3 shows example instructions in accordance with teachings of this disclosure.

FIG. 4 illustrates a process control diagram generated in accordance with teachings disclosed herein.

FIGS. 5 and 6 are flowcharts representative of example machine readable instructions and/or example operations that may be executed, instantiated, and/or performed by example programmable circuitry to implement the diagram manager circuitry of FIG. 1.

FIG. 7 is a block diagram of an example processing platform including programmable circuitry structured to execute, instantiate, and/or perform the example machine readable instructions and/or perform the example operations of FIGS. 5 and 6 to implement the diagram manager circuitry of FIG. 1.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

A process control system can include a plurality of field devices that provide different functional capabilities, and which are typically communicatively coupled to process controllers. In some examples, data associated with such process control systems can be displayed as graphics within a user interface (UI). The graphics may include charts, graphs, diagrams, pictures, tables, connectors, etc. In some examples, the graphics can provide a numerical and/or pictorial representation of the data that operators, engineers and/or other process control personnel use to monitor, control, and evaluate the performance of a process control system.

Process control systems are typically configured using configuration applications that enable a system engineer, operator, user, etc., to define how each field device within a process control system should function for a particular process (e.g., a particular chemical production process). When a field device is added to a particular process or each time a change is made to the process, an engineer may manually generate a new control program or new configuration data, or the engineer may manually update or modify an existing control program. Each process may use a large number (e.g., hundreds, thousands, etc.) of field devices, controllers, and/or other control devices and, thus, a control program may include large amounts of configuration data. Further, each device and/or controller may have identification information and/or graphical representations that vary by customer, manufacturer, supplier, etc. If any of this information is inaccurate (e.g., out of date, inconsistent, etc.), then the new device or configuration may not be effectively integrated into the control program. As such, the tasks of configuring new field devices, modifying process control schemes, etc., is time-consuming and subject to human error.

Examples disclosed herein interpret, modify, and/or represent components of a process control system to be presented on workstations operating in the process control system. Disclosed examples can generate and/or otherwise update process control diagrams, such as piping and instrumentation diagrams (P&IDs) or process flow diagrams (PFDs), with little to no human intervention. For example, disclosed examples can access an image (e.g., a sketch, a photograph, etc.) of a component in a process control system to, in turn, obtain identifying information, operating parameters, graphical representations, etc., of the component without having to rely on an engineer's understanding/knowledge of the process control system. In turn, disclosed examples utilize this information to generate/update the process control diagram. Additionally, disclosed examples can detect inputs (e.g., interactions, user actions, etc.) to the diagrams to, in turn, automatically update the diagrams without having to print and manually mark up any changes, updates, corrections, etc., associated with the process control system. As such, examples disclosed herein reduce or eliminate the manual effort needed to implement modifications to control routines and/or implement components of a process control system. Further, disclosed examples ensure device information and control scheme data are accurate by limiting human involvement.

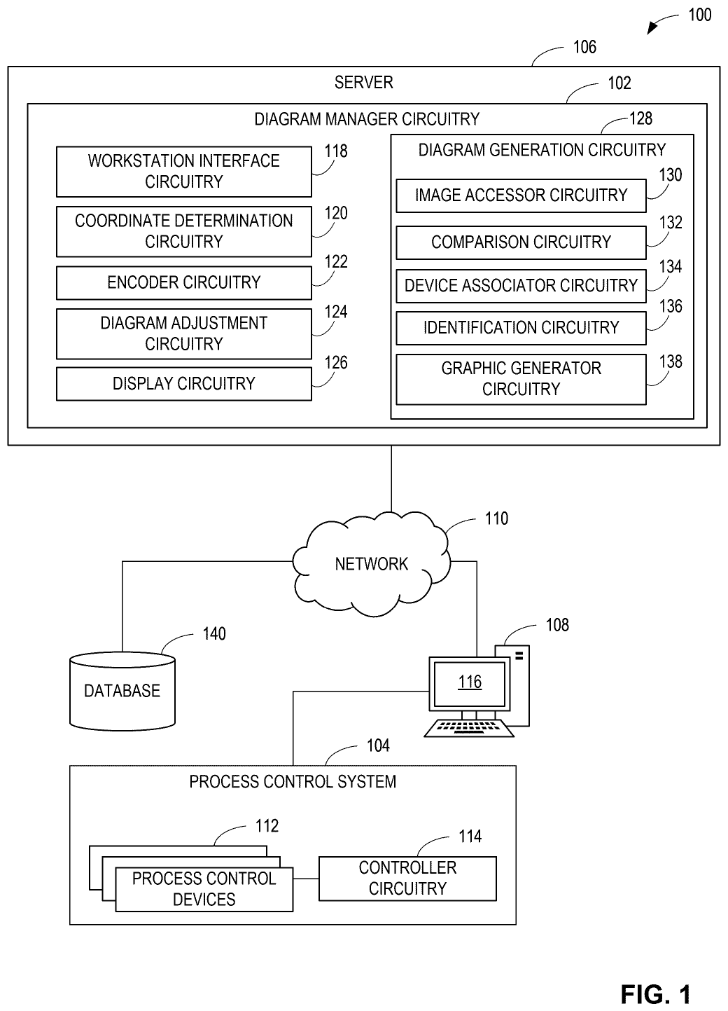

FIG. 1 is a block diagram of an example environment 100 in which example diagram manager circuitry 102 operates to generate process control diagrams that represent an example process control system 104. In this example, the diagram manager circuitry 102 is included in an example server 106 communicatively coupled to an example workstation 108 via an example network 110. In some examples, the network 110 is the Internet. However, the example network 110 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc.

In other examples, the diagram manager circuitry 102 may be implemented by and/or included within the example workstation 108. The example environment 100 includes the process control system 104 such as a manufacturing facility, process facility, automation facility, and/or any other type of process control structure. Further, the example process control system 104 includes example process control devices 112 (e.g., field devices, component devices, etc.) or, as also referred to herein, the devices 112. The example process control devices 112 may include any type(s) of process control component(s) capable of receiving inputs, generating outputs, and/or controlling a process. For example, the process control devices 112 may include valves, pumps, fans, heaters, coolers, strippers, tanks, drums, coalescers, separators, reactors, desalters, piping, etc., to control a process. Additionally, the process control devices 112 may include measurement and/or monitoring devices such as temperature sensors, pressure sensors, concentration sensors, fluid level meters, flow meters, and/or vapor sensors to measure portions of a process. The example process control devices 112 receive instructions from example controller circuitry 114 to execute specified operations and/or cause a change to the process implemented and/or controlled by the process control devices 112. Further, the example process control devices 112 measure process data, environmental data, and/or input device data and transmit the measured data to the controller circuitry 114 as process control information. The example controller circuitry 114 may be control logic circuitry, such as a DeltaV controller, an Integrated Control and Safety Systems (ICSS) controller, etc., configured to control/manage/monitor the process control system 104 via the workstation 108.

The example controller circuitry 114 transmits data to the workstation 108 at periodic or aperiodic intervals. The example workstation 108 may include any computing device such as a personal computer, a laptop, a server, etc. The example workstation 108 includes an example user interface (UI) 116 to enable an operator to review and/or operate the process control devices 112, the controller circuitry 114, and the process control system 104 via the workstation 108. In the example of FIG. 1, the UI 116 includes a diagram (e.g., chart, graph, etc.) that represents the process control system 104, operations of the controller circuitry 114, operations of the process control devices 112, etc. For example, the diagram may be a P&ID, a PFD, etc., illustrating the process control devices 112, measurement equipment, notes, pipe connections, process lines, etc. The example UI 116 enables a user to manage such a diagram and, thus, the process control system 104, by providing graphical instrumentality (e.g., keyboard, pointer device, touchscreen, etc.) that the user may select and/or manipulate to cause the workstation 108 to send instructions to the controller circuitry 114. In some examples, the UI 116 may also be referred to as a console display or human machine interface (HMI).

FIG. 1 includes a block diagram of an example implementation of the diagram manager circuitry 102 to generate, modify, update, etc., process control diagrams that represent the process control system 104. The example diagram manager circuitry 102 includes example workstation interface circuitry 118, example coordinate determination circuitry 120, example encoder circuitry 122, example diagram adjustment circuitry 124, example display circuitry 126, and example diagram generation circuitry 128. The example diagram generation circuitry 128 includes example image accessor circuitry 130, example comparison circuitry 132, example device associator circuitry 134, example identification circuitry 136, and example graphic generator circuitry 138. The diagram manager circuitry 102 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the diagram manager circuitry 102 of FIG. 1 may be instantiated (e.g., creating an instance of, bring into being for any length of time, materialize, implement, etc.) by an Application Specific Integrated Circuit (ASIC) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions to implement one or more virtual machines and/or containers.

The example diagram generation circuitry 128 generates an example diagram that graphically represents at least a portion of the process control system 104. The example image accessor circuitry 130 accesses an example input image representing a first component in the process control system 104. In some examples, the image accessor circuitry 130 can access and/or otherwise read hand drawn sketches, photographs, screenshots, computer-generated images (e.g., three dimensional (3D) model), etc., that represent component(s) (e.g., the process control devices 112) in the process control system 104.

The example comparison circuitry 132 identifies the first component as a first one of the process control devices 112. In some examples, the comparison circuitry 132 uses image processing/recognition techniques to identify the first component in the input image. For example, the comparison circuitry 132 compares the input image to images in an example database 140 associated with the process control system 104. The example images stored in the database 140 are associated with the process control devices 112 operable in the process control system 104. Further, the example images have corresponding identifying information for the process control devices 112. The example comparison circuitry 132 determines whether the input image matches any (e.g., one) of the images in the database 140. The example comparison circuitry 132 can determine that the input image matches a first image in the database 140 via template matching image processing.

In some examples, the example device associator circuitry 134 associates (e.g., matches, pairs, etc.) the first component with the first one of the process control devices 112 when the input image matches the image of the first one of the process control devices 112. In some examples, the first component shares identifying information (e.g., device name, device type, manufacturer name, operating parameters, etc.) with the first one of the process control devices 112. For example, the first component may be the same device as the first one of the process control devices 112. In some examples, the identifying information may include relational data between the first one of the process control devices 112 and the process control devices 112 (e.g., how the first one of the process control devices 112 fits into and/or is related to the process control system 104).

The example identification circuitry 136 obtains, gathers, parses, etc., at least a portion of the identifying information associated with the first component. In turn, the example graphic generator circuitry 138 generates a graphical representation of the first component. In some examples, when the comparison circuitry 132 determines that input image does not match any of the images in the database 140, the graphic generator circuitry 138 can generate a graphical representation of the first component based on the input image and/or any other input data associated with the input image (e.g., operator note). In turn, the example diagram generation circuitry 128 generates a diagram including the graphical representation of the first component, graphical representations of additional components, etc.

The example workstation interface circuitry 118 displays the diagram on the UI 116 associated with the workstation 108 operating in the process control system 104. Further, the example workstation interface circuitry 118 monitors, detects, accesses, etc., interactions with the UI 116. In some examples, the workstation interface circuitry 118 monitors interactions that change at least one characteristic (e.g., relationship, connection, dependencies, etc.) between the components in the diagram. For example, the workstation interface circuitry 118 can access an interaction with the UI 116 that indicates a connection between the graphical representation of the first component and a graphical representation of a second component, the graphical representations included in the diagram. In some examples, the workstation interface circuitry 118 can monitor activity of the instrumentality (e.g., a mouse, a keyboard, etc.) associated with the UI 116 to detect the interaction. For example, the workstation interface circuitry 118 can detect an interaction with the diagram when an operator of the workstation 108 draws/traces a line between the first component and the second component on the diagram via a mouse. In some examples, this interaction may serve as input data (e.g., a process line, a pipe, an electrical connection, etc.) to the diagram.

The example coordinate determination circuitry 120 determines coordinate locations associated with the input data within the diagram. For example, the coordinate determination circuitry 120 can determine coordinates (e.g., positions) of the interactions relative to the diagram displayed on the UI 116. In some examples, the coordinate determination circuitry 120 can determine the coordinate locations by detecting the interaction on the diagram, comparing a location of the interaction with axes defined by the borders/boundaries of the UI 116, defining the location of the interaction as height/width, x location/y location, etc.

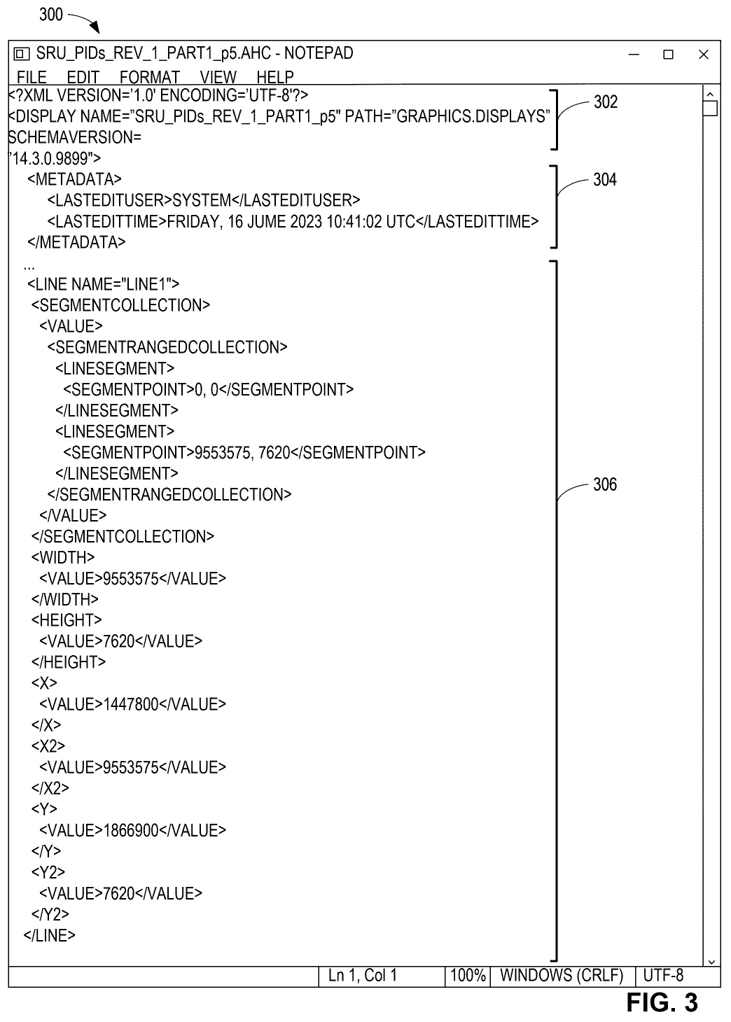

The example encoder circuitry 122 generates example machine-readable instructions including information corresponding to the coordinate locations. In some examples, the machine-readable instructions may be an Extensible Markup Language (XML) file, as described in detail in connection with FIG. 3. The example encoder circuitry 122 generates the machine-readable instructions to cause a change to the diagram based on the input data, the changed diagram indicating the relationship/connection between the components (e.g., the first component and the second component). In some examples, the example diagram adjustment circuitry 124 causes execution of the machine-readable instructions to change, edit, update, etc., the diagram to indicate the relationship/connection between the first component and the second component. In some examples, the diagram adjustment circuitry 124 is communicatively coupled to graphics software (e.g., DeltaV Live Graphics Studio) to change the diagram according to the machine-readable instructions. In turn, the example display circuitry 126 displays the changed diagram on the UI 116 of the workstation 108.

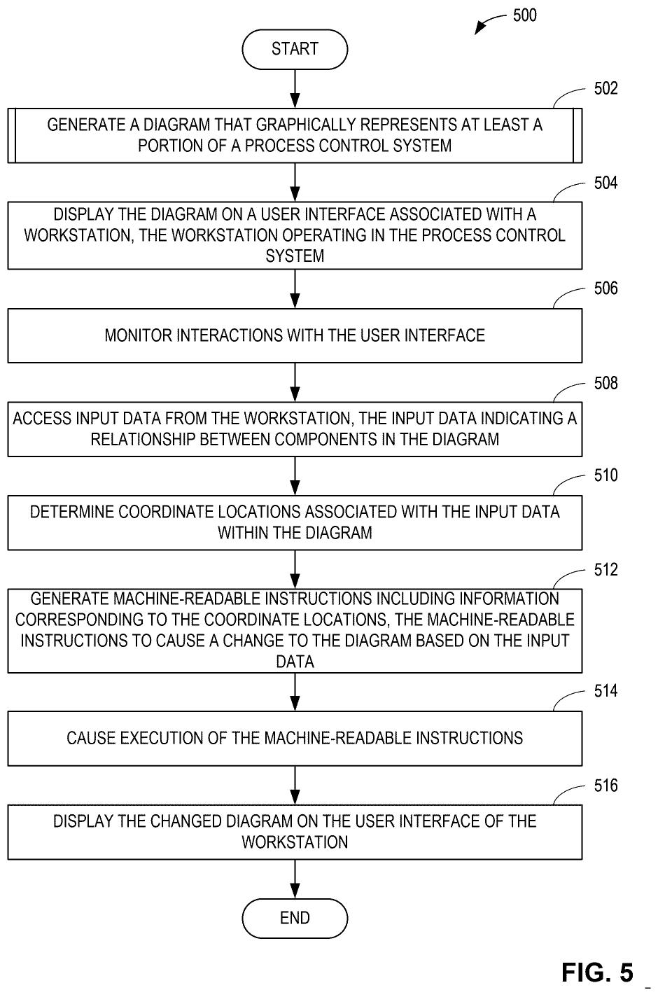

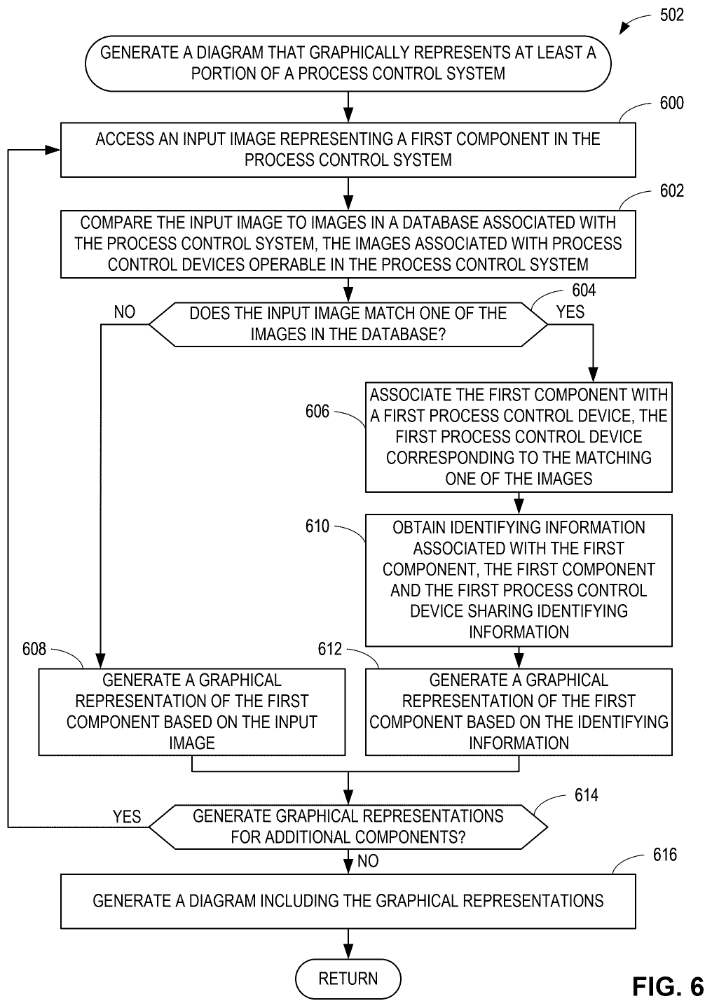

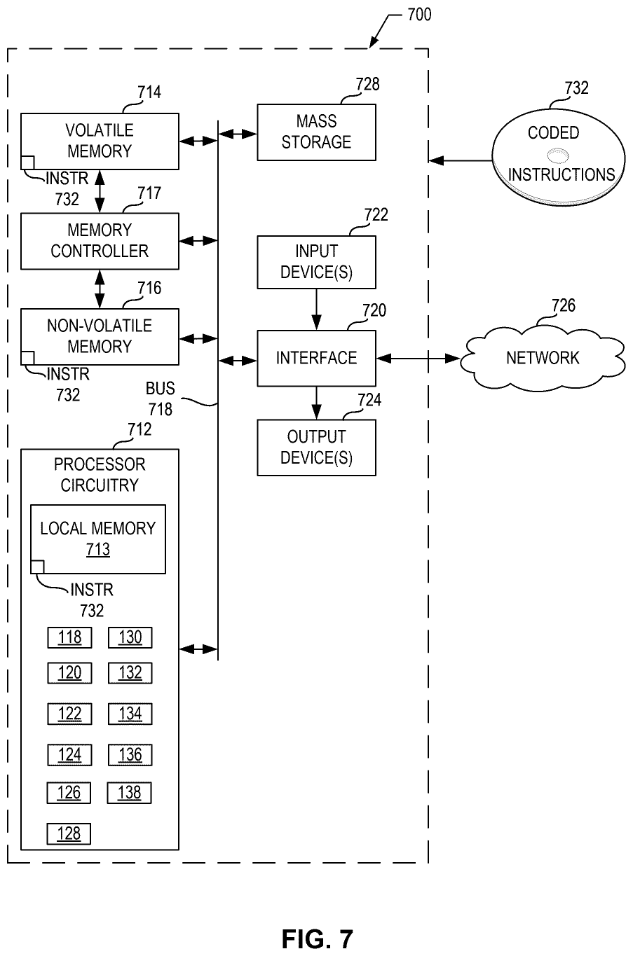

In some examples, the diagram generation circuitry 128 is instantiated by programmable circuitry executing diagram generation instructions and/or configured to perform operations such as those represented by the flowchart(s) of FIGS. 5 and 6. In some examples, the diagram manager circuitry 102 includes first means for generating a diagram that graphically represents at least a portion of a process control system. For example, the means for determining may be implemented by the diagram generation circuitry 128. In some examples, the diagram generation circuitry 128 may be instantiated by programmable circuitry such as the example programmable circuitry 712 of FIG. 7. For instance, the diagram generation circuitry 128 may be executing machine executable instructions such as those implemented by at least blocks 502 of FIG. 5 and blocks 614, 616 of FIG. 6. Additionally or alternatively, the diagram generation circuitry 128 may be instantiated by any other combination of hardware, software, and/or firmware. For example, the diagram generation circuitry 128 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the image accessor circuitry 130 is instantiated by programmable circuitry executing image accessing instructions and/or configured to perform operations such as those represented by the flowchart(s) of FIGS. 5 and 6. In some examples, the first means for generating includes means for accessing images. For example, the means for accessing may be implemented by the image accessor circuitry 130. In some examples, the image accessor circuitry 130 may be instantiated by programmable circuitry such as the example programmable circuitry 712 of FIG. 7. For instance, the image accessor circuitry 130 may be executing machine executable instructions such as those implemented by at least block 600 of FIG. 6. Additionally or alternatively, the image accessor circuitry 130 may be instantiated by any other combination of hardware, software, and/or firmware. For example, the image accessor circuitry 130 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the comparison circuitry 132 is instantiated by programmable circuitry executing comparison instructions and/or configured to perform operations such as those represented by the flowchart(s) of FIGS. 5 and 6. In some examples, the first means for generating includes means for comparing images. For example, the means for comparing may be implemented by the comparison circuitry 132. In some examples, the comparison circuitry 132 may be instantiated by programmable circuitry such as the example programmable circuitry 712 of FIG. 7. For instance, the comparison circuitry 132 may be executing machine executable instructions such as those implemented by at least blocks 602, 604 of FIG. 6. Additionally or alternatively, the comparison circuitry 132 may be instantiated by any other combination of hardware, software, and/or firmware. For example, the comparison circuitry 132 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the device associator circuitry 134 is instantiated by programmable circuitry executing association instructions and/or configured to perform operations such as those represented by the flowchart(s) of FIGS. 5 and 6. In some examples, the first means for generating includes means for associating images and/or components within a process control system. For example, the means for associating may be implemented by the device associator circuitry 134. In some examples, the device associator circuitry 134 may be instantiated by programmable circuitry such as the example programmable circuitry 712 of FIG. 7. For instance, the device associator circuitry 134 may be executing machine executable instructions such as those implemented by at least block 606 of FIG. 6. Additionally or alternatively, the device associator circuitry 134 may be instantiated by any other combination of hardware, software, and/or firmware. For example, the device associator circuitry 134 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the identification circuitry 136 is instantiated by programmable circuitry executing identification instructions and/or configured to perform operations such as those represented by the flowchart(s) of FIGS. 5 and 6. In some examples, the first means for generating includes means for identifying information pertaining to a process control device. For example, the means for identifying may be implemented by the identification circuitry 136. In some examples, the identification circuitry 136 may be instantiated by programmable circuitry such as the example programmable circuitry 712 of FIG. 7. For instance, the identification circuitry 136 may be executing machine executable instructions such as those implemented by at least block 610 of FIG. 6. Additionally or alternatively, the identification circuitry 136 may be instantiated by any other combination of hardware, software, and/or firmware. For example, the identification circuitry 136 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the graphic generator circuitry 138 is instantiated by programmable circuitry executing graphic generating instructions and/or configured to perform operations such as those represented by the flowchart(s) of FIGS. 5 and 6. In some examples, the first means for generating includes second means for generating graphical representations. For example, the second means for generating may be implemented by the graphic generator circuitry 138. In some examples, the graphic generator circuitry 138 may be instantiated by programmable circuitry such as the example programmable circuitry 712 of FIG. 7. For instance, the graphic generator circuitry 138 may be executing machine executable instructions such as those implemented by at least blocks 608, 612 of FIG. 6. Additionally or alternatively, the graphic generator circuitry 138 may be instantiated by any other combination of hardware, software, and/or firmware. For example, the graphic generator circuitry 138 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the workstation interface circuitry 118 is instantiated by programmable circuitry executing monitoring instructions and/or configured to perform operations such as those represented by the flowchart of FIG. 5. In some examples, the diagram manager circuitry 102 includes means for monitoring a UI of an example workstation. For example, the means for monitoring may be implemented by the workstation interface circuitry 118. In some examples, the workstation interface circuitry 118 may be instantiated by programmable circuitry such as the example programmable circuitry 712 of FIG. 7. For instance, the workstation interface circuitry 118 may be executing machine executable instructions such as those implemented by at least blocks 504, 506, 508 of FIG. 5. Additionally or alternatively, the workstation interface circuitry 118 may be instantiated by any other combination of hardware, software, and/or firmware. For example, the workstation interface circuitry 118 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the coordinate determination circuitry 120 is instantiated by programmable circuitry executing determination instructions and/or configured to perform operations such as those represented by the flowchart of FIG. 5. In some examples, the diagram manager circuitry 102 includes means for determining coordinates. For example, the means for determining may be implemented by the coordinate determination circuitry 120. In some examples, the coordinate determination circuitry 120 may be instantiated by programmable circuitry such as the example programmable circuitry 712 of FIG. 7. For instance, the coordinate determination circuitry 120 may be executing machine executable instructions such as those implemented by at least block 510 of FIG. 5. Additionally or alternatively, the coordinate determination circuitry 120 may be instantiated by any other combination of hardware, software, and/or firmware. For example, the coordinate determination circuitry 120 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the encoder circuitry 122 is instantiated by programmable circuitry executing generation instructions and/or configured to perform operations such as those represented by the flowchart of FIG. 5. In some examples, the diagram manager circuitry 102 includes third means for generating machine-readable instructions. For example, the third means for generating may be implemented by the encoder circuitry 122. In some examples, the encoder circuitry 122 may be instantiated by programmable circuitry such as the example programmable circuitry 712 of FIG. 7. For instance, the encoder circuitry 122 may be executing machine executable instructions such as those implemented by at least block 512 of FIG. 5. Additionally or alternatively, the encoder circuitry 122 may be instantiated by any other combination of hardware, software, and/or firmware. For example, the encoder circuitry 122 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the diagram adjustment circuitry 124 is instantiated by programmable circuitry executing adjustment instructions and/or configured to perform operations such as those represented by the flowchart of FIG. 5. In some examples, the diagram manager circuitry 102 includes means for adjusting a diagram. For example, the means for adjusting may be implemented by the diagram adjustment circuitry 124. In some examples, the diagram adjustment circuitry 124 may be instantiated by programmable circuitry such as the example programmable circuitry 712 of FIG. 7. For instance, the diagram adjustment circuitry 124 may be executing machine executable instructions such as those implemented by at least block 514 of FIG. 5. Additionally or alternatively, the diagram adjustment circuitry 124 may be instantiated by any other combination of hardware, software, and/or firmware. For example, the diagram adjustment circuitry 124 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the display circuitry 126 is instantiated by programmable circuitry executing display instructions and/or configured to perform operations such as those represented by the flowchart of FIG. 5. In some examples, the diagram manager circuitry 102 includes means for displaying a changed diagram. For example, the means for displaying may be implemented by the display circuitry 126. In some examples, the display circuitry 126 may be instantiated by programmable circuitry such as the example programmable circuitry 712 of FIG. 7. For instance, the display circuitry 126 may be executing machine executable instructions such as those implemented by at least block 516 of FIG. 5. Additionally or alternatively, the display circuitry 126 may be instantiated by any other combination of hardware, software, and/or firmware. For example, the display circuitry 126 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

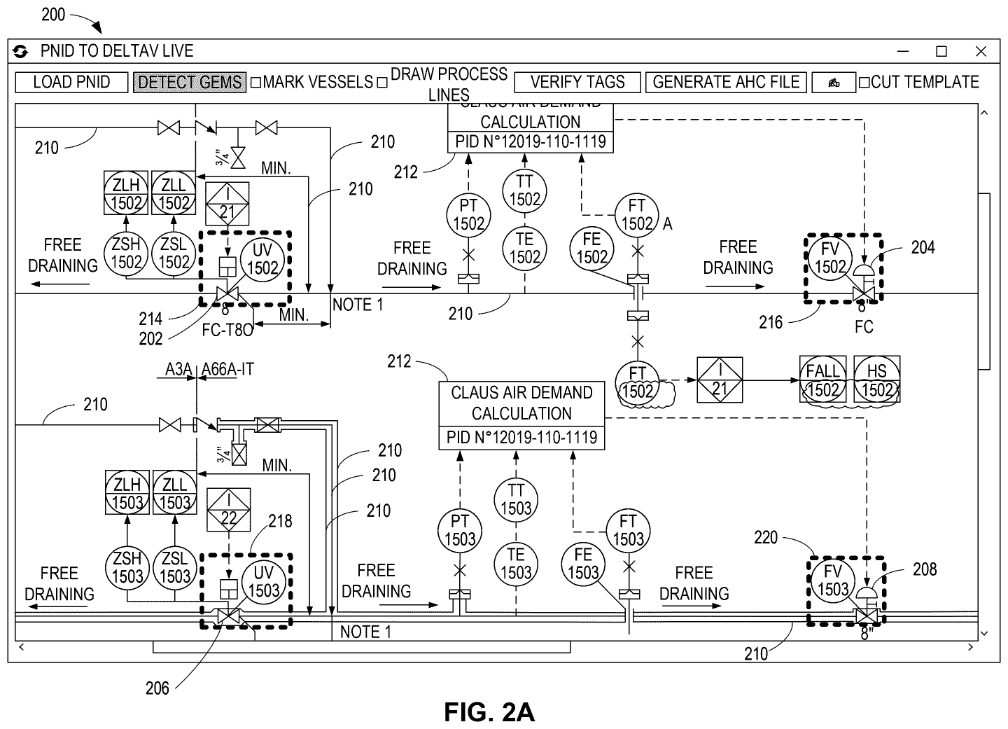

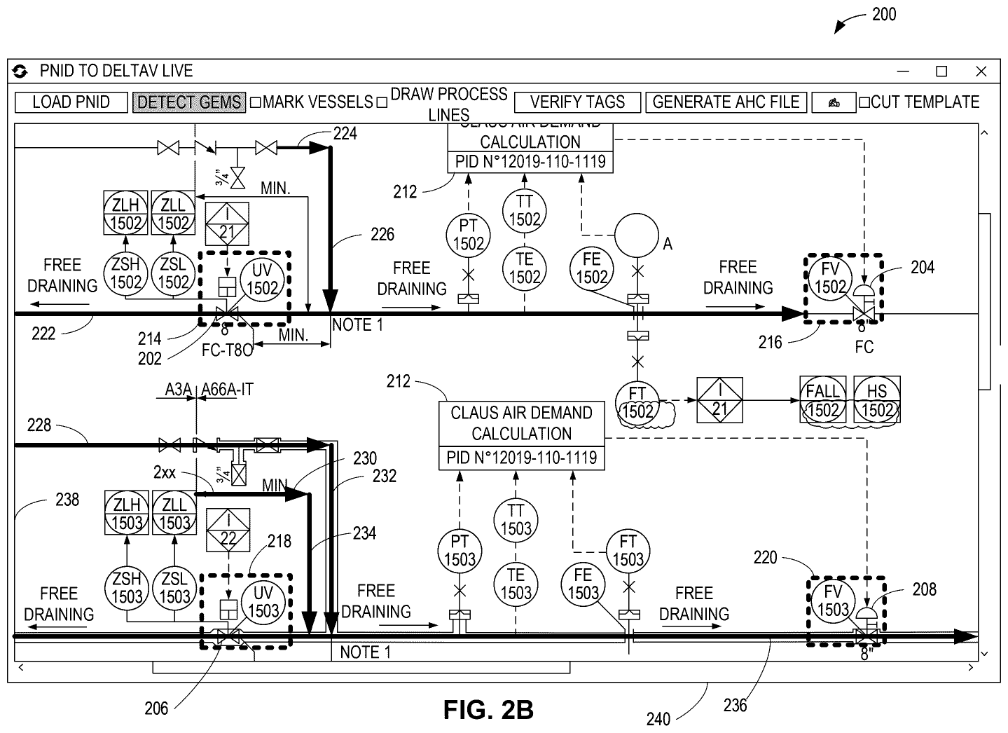

FIGS. 2A and 2B illustrate an example diagram 200 generated by the example diagram generation circuitry 128. Thus, the diagram 200 may be implemented as the diagram presented on the UI 116 of the workstation 108 in FIG. 1. In this example, the diagram 200 is a P&ID including, but not limited to, example devices 202, 204, 206, 208, example process lines 210, and example notes 212. The example diagram 200 represents the process control system 104 described in connection with FIG. 1. As such, the example devices 202, 204, 206, 208 can correspond to the process control devices 112. The example diagram generation circuitry 128 can generate graphical representations of the devices 202, 204, 206, 208, as shown in FIGS. 2A and 2B.

The example diagram manager circuitry 102 can access input data such as, for example, device selections. In FIG. 2A, example device selections 214, 216, 218, 220 indicate that the devices 202, 204, 206, 208 are utilized in a control scheme that is otherwise significant, useful, of interest, etc., to the process control system 104 and/or an operator of the workstation 108 in the process control system 104. In some examples, the device selections 214, 216, 218, 220 are detected based on interactions with instrumentality associated with the workstation 108. For example, an operator of the workstation 108 may click (e.g., via a mouse, keyboard, etc.) on the graphical representations (e.g., icons) associated with the devices 202, 204, 206, 208 on the UI 116.

In FIG. 2B, the example diagram manager circuitry 102 can access input data that indicates relationships (e.g., dependencies, connections, etc.) between the devices 202, 204, 206, 208. The example diagram manager circuitry 102 can access tracings, markups, etc., that indicate the relationships. For example, arrows 222, 224, 226, 228, 230, 232, 234, 236 are tracings that indicate a procedural and/or otherwise dependent relationship between at least the device 202 and the device 204, the device 206 and the device 208, etc. In some examples, the arrows 222, 224, 226, 228, 230, 232, 234, 236 are detected based on interactions with instrumentality associated with the workstation 108. For example, an operator of the workstation 108 may click and drag, type a command, etc., on/to the diagram 200 to input the process line connections associated with the arrows 222, 224, 226, 228, 230, 232, 234, 236. In some examples, the diagram manager circuitry 102 can determine €coordinates (e.g., positions, locations, regions, etc.) of the arrows 222, 224, 226, 228, 230, 232, 234, 236 and, in turn, generate machine-readable instructions to cause a change to the diagram 200 based on the input data. In some examples, the coordinates may be defined by boundaries of the diagram. For example, an example boundary 238 can define a y axis and an example boundary 240 can define an x axis. In some examples, the changed diagram can indicate the relationships and the device selections 214, 216, 218, 220 in a manner useful to an operator of the UI 116 associated with the workstation 108.

FIG. 3 illustrates example machine-readable instructions 300 constructed in accordance with examples disclosed herein. The example diagram manager circuitry 102 generates the machine-readable instructions 300 based on the input data described in connection with FIGS. 2A and 2B. In this example, the machine-readable instructions 300 are implemented as an XML file. However, the machine-readable instructions 300 may be implemented as any type of code, file, etc. Further, the example machine-readable instructions 300 in FIG. 3 illustrate a portion of the machine-readable instructions that can be generated (e.g., by the encoder circuitry 122) to describe the input data from FIGS. 2A and 2B. The example machine-readable instructions 300 include a file name, navigation path, a version description, etc., in example portion 302. Further, example portion 304 of the machine-readable instructions 300 include account information. In some examples, the account information in portion 304 can indicate a user and/or a user account of the workstation 108 that provided the input data (e.g., via instrumentality associated with the UI 116). Further, the portion 304 includes time data (e.g., timestamps, date, etc.) associated with the input data. The example machine-readable instructions 300 can include information pertaining to the process control system 104 such as, for example, title, language, etc. The machine-readable instructions 300 may include multiple sub nodes depending on the elements, components, devices, etc., included in the process control system 104. Further, the machine-readable instructions 300 can indicate textual information (e.g., the notes 212 of FIGS. 2A and 2B), traced process lines (e.g., the arrows 222, 224, 226, 228, 230, 232, 234, 236), devices (e.g., the devices 202, 204, 206, 208), etc. In some examples, the machine-readable instructions 300 can include properties, parameters, operating data, etc., associated with the components in the process control system 104.

The example machine-readable instructions 300 describe the coordinates of the input data in example portion 306. In the example of FIG. 3, the machine-readable instructions 300 illustrate coordinate data associated with a line drawn between components (e.g., the device 202 and the device 204). For example, portion 306 includes a height value (e.g., 7620), a width value (e.g., 9553575), a first x value (e.g., 1447800), a first y value (e.g., 1866900), etc. These example values indicate coordinate information associated with the line drawn relative to an example diagram (e.g., the diagram 200). As such, the machine-readable instructions 300 can represent the input data in FIGS. 2A and 2B as values, code, instructions, etc.

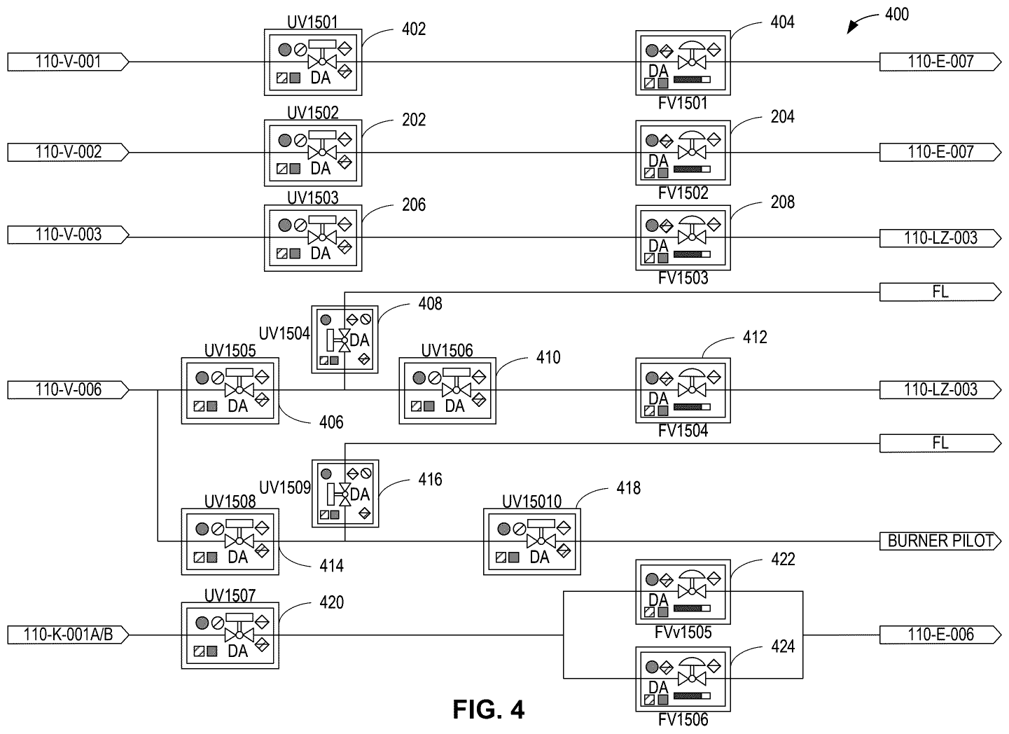

FIG. 4 illustrates an example changed diagram 400 generated in accordance with teachings disclosed herein. In some examples, the diagram adjustment circuitry 124 executes the machine-readable instructions 300 to generate the changed diagram 400. In some examples, the example diagram adjustment circuitry 124 causes execution of the machine-readable instructions 300 to change, edit, update, etc., the diagram 200 to indicate the relationship/connection between the device 202 and the device 204. As shown in FIG. 4, the device 202 is connected to the device 204 via a line. As such, the example diagram manager circuitry 102 has accessed the input data (e.g., arrow 222 from FIG. 2B), generated the machine-readable instructions 300 to capture the input data as coordinate locations (e.g., portion 306 in FIG. 3), and changed the diagram 200 into the diagram 400 to illustrate the relationship between the devices 202, 204. Similarly, the example diagram manager circuitry 102 can generate the changed diagram 400 to include relationships between the devices 206, 208, example devices 402, 404, example devices 406, 408, 410, 412, 414, 416, 418, example devices 420, 422, 424. In some examples, the diagram adjustment circuitry 124 is communicatively coupled to graphics software (e.g., DeltaV Live Graphics Studio) to change the diagram 200 into the diagram 400 according to the machine-readable instructions 300.

While an example manner of implementing the diagram manager circuitry 102 of FIG. 1 is illustrated in FIG. 1, one or more of the elements, processes, and/or devices illustrated in FIG. 1 may be combined, divided, re-arranged, omitted, eliminated, and/or implemented in any other way. Further, the example workstation interface circuitry 118, example coordinate determination circuitry 120, example encoder circuitry 122, example diagram adjustment circuitry 124, example display circuitry 126, and example diagram generation circuitry 128, the example image accessor circuitry 130, example comparison circuitry 132, example device associator circuitry 134, example identification circuitry 136, and example graphic generator circuitry 138 and/or, more generally, the example diagram manager circuitry 102 of FIG. 1, may be implemented by hardware alone or by hardware in combination with software and/or firmware. Thus, for example, any of the example workstation interface circuitry 118, example coordinate determination circuitry 120, example encoder circuitry 122, example diagram adjustment circuitry 124, example display circuitry 126, and example diagram generation circuitry 128, the example image accessor circuitry 130, example comparison circuitry 132, example device associator circuitry 134, example identification circuitry 136, and example graphic generator circuitry 138, and/or, more generally, the example diagram manager circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), and/or programmable logic device(s) (PLD(s)). Further still, the example diagram manager circuitry 102 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the diagram manager circuitry 102 of FIG. 1 and/or representative of example operations which may be performed by programmable circuitry to implement and/or instantiate the diagram manager circuitry 102 of FIG. 1, are shown in FIGS. 5 and 6. The machine readable instructions may be one or more executable programs or portion(s) of one or more executable programs for execution by programmable circuitry such as the programmable circuitry 712 shown in the example processor platform 700 discussed below in connection with FIG. 7. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5 and 6, many other methods of implementing the example diagram manager circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to generate, modify, update, etc., process control diagrams that represent the process control system 104. The example machine-readable instructions and/or the example operations 500 of FIG. 5 begin at block 502, at which the example diagram generation circuitry 128 generates an example diagram that graphically represents at least a portion of the process control system 104, further described in connection with FIG. 6.

At block 504, the example workstation interface circuitry 118 displays the diagram on the UI 116 associated with the workstation 108 operating in the process control system 104. For example, the workstation interface circuitry 118 displays the diagram 200 on the UI 116.

At block 506, the example workstation interface circuitry 118 monitors interactions with the UI 116. In some examples, the workstation interface circuitry 118 monitors interactions (e.g., via instrumentality associated with the workstation 108) with the graphical representations of the components in the diagram 200. For example, the workstation interface circuitry 118 can detect an interaction with the diagram 200 when an operator of the workstation 108 draws/traces a line (e.g., along a direction of the arrow 222) with a mouse between the device 202 and the device 204.

At block 508, the example workstation interface circuitry 118 access input data from the workstation 108, the input data indicating a relationship between components in the diagram 200. For example, the workstation interface circuitry 118 can access the interactions with the UI 116 as input data that indicates a relationship (e.g., a process line, a pipe, an electrical connection, etc.) between components (e.g., the devices 202, 204).

At block 510, the example coordinate determination circuitry 120 determines coordinate locations associated with the input data within the diagram 200. For example, the coordinate determination circuitry 120 determines coordinates of the arrows 222, 224, 226, 228, 230, 232, 234, 236 (FIG. 2B). Further, the example coordinate determination circuitry 120 determines the coordinate locations relative to the boundaries 238, 240 of the diagram 200 and/or display screen of the UI 116.

At block 512, the example encoder circuitry 122 generates the machine-readable instructions 300 including information corresponding to the coordinate locations. The example encoder circuitry 122 generates the machine-readable instructions 300 to cause a change to the diagram 200 based on the input data to indicate the relationship/connection between the components (e.g., the device 202 and the device 204). The example encoder circuitry 122 generates the machine-readable instructions 300 to include the coordinate locations in at least portion 306.

At block 514, the example diagram adjustment circuitry 124 causes execution of the machine-readable instructions 300 to change, edit, update, etc., the diagram 200. In some examples, the example diagram adjustment circuitry 124 causes execution of the machine-readable instructions 300 to change, edit, update, etc., the diagram 200 to the changed diagram 400 to indicate the relationship/connection between the device 202 and the device 204. In some examples, the diagram adjustment circuitry 124 is communicatively coupled to graphics software (e.g., DeltaV Live Graphics Studio) to change the diagram 200 into the diagram 400 according to the machine-readable instructions 300.

At block 516, the example display circuitry 126 displays the changed diagram 400 on the UI 116 of the workstation 108. Then, the process ends.

FIG. 6 is a flowchart representative of example machine readable instructions and/or example operations that may be executed, instantiated, and/or performed by programmable circuitry to implement the example diagram generation circuitry 128, described in connection with block 502 of FIG. 5, to generate an example diagram that graphically represents at least a portion of the process control system 104. The example machine-readable instructions and/or the example operations 502 of FIG. 6 begin at block 600, at which the example image accessor circuitry 130 accesses an example input image representing a first component in the process control system 104. For example, the image accessor circuitry 130 can access a hand drawn sketch, photograph, screenshot, computer-generated 3D model, etc., that represents the first component in the process control system 104.

At block 602, the example comparison circuitry 132 compares the input image to images in the database 140 associated with the process control system 104, the images stored in the database 140 are associated with the process control devices 112 operable in the process control system 104. Further, the example images have corresponding identifying information for the process control devices 112.

At block 604, the example comparison circuitry 132 determines whether the input image matches one of the images in the database 140. The example comparison circuitry 132 can determine whether the input image matches a first image in the database 140 via template matching image processing and/or any other image processing/recognition technologies. If the comparison circuitry 132 determines that the input image matches one of the images in the database 140, control of the process proceeds to block 606. Alternatively, if the comparison circuitry 132 determines that the input image does not match any of the images in the database 140, control of the process proceeds to block 608.

At block 606, the example device associator circuitry 134 associates (e.g., matches, pairs, etc.) the first component with the first one of the process control devices 112 when the input image matches the image of the first one of the process control devices 112. In some examples, the first component may be the same device as the first one of the process control devices 112.

At block 610, the example identification circuitry 136 obtains at least a portion of the identifying information associated with the first component. In some examples, the first component shares identifying information (e.g., device name, device type, manufacturer name, operating parameters, etc.) with the first one of the process control devices 112. In some examples, the identifying information may include relational data between the first one of the process control devices 112 and the process control devices 112 (e.g., how the first one of the process control devices 112 fits into and/or is related to the process control system 104).

At block 612, the example graphic generator circuitry 138 generates a graphical representation of the first component based on the identifying information. For example, the graphic generator circuitry 138 can generate any of the icons, widgets, shapes, etc., associated with the devices 202, 204, 206, 208 in the diagram 200 of FIGS. 2A and 2B.

At block 608, when the comparison circuitry 132 determines that the input image does not match any of the images in the database 140, the graphic generator circuitry 138 can generate a graphical representation of the first component based on the input image. In some examples, the graphic generator circuitry 138 can generate a graphical representation of the first component based on any other input data associated with the input image (e.g., operator note).

At block 614, the example diagram generation circuitry 128 determines whether there are additional components for which to generate graphical representations. If the diagram generation circuitry 128 determines that there are additional components for which to generate graphical representations, then control of the process returns to block 600. Alternatively, if the diagram generation circuitry 128 determines there are no other components for which to generate graphical representations, then control of the process proceeds to block 616.

At block 616, the example diagram generation circuitry 128 generates a diagram including the graphical representation of the first component, graphical representations of additional components, etc. For example, the diagram generation circuitry 128 generates the diagram 200 including the graphical representations of the device 202, graphical representations of the devices 204, 204, 208, etc. Then, control of the process returns to block 504 in FIG. 5.

FIG. 7 is a block diagram of an example programmable circuitry platform 700 structured to execute and/or instantiate the example machine-readable instructions and/or the example operations of FIGS. 5 and 6 to implement the diagram manager circuitry 102 of FIG. 1. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements example workstation interface circuitry 118, example coordinate determination circuitry 120, example encoder circuitry 122, example diagram adjustment circuitry 124, example display circuitry 126, and example diagram generation circuitry 128, the example image accessor circuitry 130, example comparison circuitry 132, example device associator circuitry 134, example identification circuitry 136, and example graphic generator circuitry 138.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and 6, may be stored in the mass storage device 728, in the volatile memory 714, in the non-volatile memory 716, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that generate and/or otherwise update process control diagrams, such as P&IDs and/or PFDs, with little to no human intervention. For example, disclosed examples can access an image of a component in a process control system to, in turn, obtain identifying information, operating parameters, graphical representations, etc., of the component without having to rely on an engineer's understanding/knowledge of the process control system. In turn, disclosed examples utilize this information to generate/update the process control diagram. Additionally, disclosed examples can detect inputs (e.g., interactions, user actions, etc.) to the diagrams to, in turn, automatically update the diagrams without having to print and manually mark up any changes, updates, corrections, etc., associated with the process control system. Disclosed systems, apparatus, articles of manufacture, and methods improve the efficiency of using a computing device by reducing or eliminating the manual effort needed to implement modifications to control routines and/or implement components of a process control system. Further, disclosed examples ensure device information and control scheme data are accurate by limiting human involvement. Disclosed systems, apparatus, articles of manufacture, and methods are accordingly directed to one or more improvement(s) in the operation of a machine such as a computer or other electronic and/or mechanical device.

Example 1 includes an apparatus comprising interface circuitry, first machine-readable instructions, and at least one processor circuit to be programmed by the first machine-readable instructions to access input data that indicates a relationship between components in a diagram, the diagram graphically representing at least a portion of a process control system, determine coordinate locations associated with the input data within the diagram, and generate second machine-readable instructions including information corresponding to the coordinate locations, the second machine-readable instructions to cause a change to the diagram based on the input data, the changed diagram indicating the relationship between the components.

Example 2 includes the apparatus of example 1, wherein the diagram includes graphical representations of the components, wherein one or more of the at least one processor circuit is to generate a first graphical representation of a first component by accessing an input image representing the first component, identifying the first component as a process control device operable in the process control system, obtaining identifying information associated with the process control device, and generating the first graphical representation based on the identifying information.

Example 3 includes the apparatus of example 2, wherein the identifying information includes at least one of operating parameters of the process control device, a manufacturer of the process control device, or relational data between the process control device and the components in the process control system.

Example 4 includes the apparatus of example 2, wherein the process control device is a first process control device, wherein an image of the first process control device is stored in a database, and wherein the one or more of the at least one processor circuit is to identify the first component as the first process control device by comparing the input image to images in the database, the images associated with process control devices, the images having corresponding identifying information for the process control devices, and when the input image matches the image of the first process control device, associating the first component with the first process control device, the first component and the first process control device sharing the identifying information.

Example 5 includes the apparatus of example 4, wherein the input image includes at least one of a hand drawn sketch, a photograph, or a computer generated three-dimensional (3D) model.

Example 6 includes the apparatus of example 4, wherein the one or more of the at least one processor circuit is to determine that the input image matches the image of the first process control device based on template matching image processing.

Example 7 includes the apparatus of example 1, wherein the diagram is a piping and instrumentation diagram (P&ID) or a process flow diagram (PFD).

Example 8 includes the apparatus of example 1, wherein the components include at least one of a process control device, measurement equipment, or control logic circuitry associated with the process control system.

Example 9 includes the apparatus of example 1, wherein the diagram is displayed on a user interface associated with a workstation, wherein one or more of the at least one processor circuit is to monitor interactions with the user interface, the interactions changing at least one relationship between the components in the diagram, and detect the input data based on the interactions with the diagram.

Example 10 includes the apparatus of example 9, wherein one or more of the at least one processor circuit is to display the changed diagram on a user interface associated with the workstation.

Example 11 includes at least one non-transitory machine-readable medium comprising first machine-readable instructions to cause at least one processor circuit to at least access input data that indicates a relationship between components in a diagram, the diagram graphically representing at least a portion of a process control system, determine coordinate locations associated with the input data within the diagram, and generate second machine-readable instructions including information corresponding to the coordinate locations, the second machine-readable instructions to cause a change to the diagram based on the input data, the changed diagram indicating the relationship between the components.

Example 12 includes the at least one non-transitory machine-readable medium of example 11, wherein the diagram includes graphical representations of the components, wherein the first machine-readable instructions are to cause one or more of the at least one processor circuit to generate a first graphical representation of a first component by accessing an input image representing the first component, identifying the first component as a process control device operable in the process control system, obtaining identifying information associated with the process control device, and generating the first graphical representation based on the identifying information.

Example 13 includes the at least one non-transitory machine-readable medium of example 12, wherein the identifying information includes at least one of operating parameters of the process control device, a manufacturer of the process control device, or relational data between the process control device and the components in the process control system.

Example 14 includes the at least one non-transitory machine-readable medium of example 12, wherein the process control device is a first process control device, wherein an image of the first process control device is stored in a database, and wherein the first machine-readable instructions are to cause one or more of the at least one processor circuit to identify the first component as the first process control device by comparing the input image to images in the database, the images associated with process control devices, the images having corresponding identifying information for the process control devices, and when the input image matches the image of the first process control device, associating the first component with the first process control device, the first component and the first process control device sharing the identifying information.

Example 15 includes the at least one non-transitory machine-readable medium of example 14, wherein the input image includes at least one of a hand drawn sketch, a photograph, or a computer generated three-dimensional (3D) model.

Example 16 includes the at least one non-transitory machine-readable medium of example 14, wherein the first machine-readable instructions are to cause one or more of the at least one processor circuit to determine that the input image matches the image of the first process control device based on template matching image processing.

Example 17 includes the at least one non-transitory machine-readable medium of example 11, wherein the diagram is a piping and instrumentation diagram (P&ID) or a process flow diagram (PFD).

Example 18 includes the at least one non-transitory machine-readable medium of example 11, wherein the components include at least one of a process control device, measurement equipment, or control logic circuitry associated with the process control system.

Example 19 includes the at least one non-transitory machine-readable medium of example 11, wherein the diagram is displayed on a user interface associated with a workstation, wherein the first machine-readable instructions are to cause one or more of the at least one processor circuit to monitor interactions with the user interface, the interactions changing at least one relationship between the components in the diagram, and detect the input data based on the interactions with the diagram.

Example 20 includes the at least one non-transitory machine-readable medium of example 19, wherein the first machine-readable instructions are to cause one or more of the at least one processor circuit to display the changed diagram on a user interface associated with the workstation.

Example 21 includes a method comprising accessing, by at least one processor circuit programmed by at least one instruction, input data that indicates a relationship between components in a diagram, the diagram graphically representing at least a portion of a process control system, determining, by one or more of the at least one processor circuit, coordinate locations associated with the input data within the diagram, and generating, by one or more of the at least one processor circuit, machine-readable instructions including information corresponding to the coordinate locations, the machine-readable instructions to cause a change to the diagram based on the input data, the changed diagram indicating the relationship between the components.

Example 22 includes the method of example 21, wherein the diagram includes graphical representations of the components, further including generating a first graphical representation of a first component by accessing an input image representing the first component, identifying the first component as a process control device operable in the process control system, obtaining identifying information associated with the process control device, and generating the first graphical representation based on the identifying information.

Example 23 includes the method of example 22, wherein the identifying information includes at least one of operating parameters of the process control device, a manufacturer of the process control device, or relational data between the process control device and the components in the process control system.

Example 24 includes the method of example 22, wherein the process control device is a first process control device, wherein an image of the first process control device is stored in a database, further including identifying the first component as the first process control device by comparing the input image to images in the database, the images associated with process control devices, the images having corresponding identifying information for the process control devices, and when the input image matches the image of the first process control device, associating the first component with the first process control device, the first component and the first process control device sharing the identifying information.

Example 25 includes the method of example 24, wherein the input image includes at least one of a hand drawn sketch, a photograph, or a computer generated three-dimensional (3D) model.

Example 26 includes the method of example 24, further including determining that the input image matches the image of the first process control device based on template matching image processing.

Example 27 includes the method of example 21, wherein the diagram is a piping and instrumentation diagram (P&ID) or a process flow diagram (PFD).

Example 28 includes the method of example 21, wherein the components include at least one of a process control device, measurement equipment, or control logic circuitry associated with the process control system.

Example 29 includes the method of example 21, wherein the diagram is displayed on a user interface associated with a workstation, further including monitoring interactions with the user interface, the interactions changing at least one relationship between the components in the diagram, and detecting the input data based on the interactions with the diagram.

Example 30 includes the method of example 29, further including displaying the changed diagram on a user interface associated with the workstation.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

### RELATED APPLICATION

This patent claims priority to Indian Patent Application number 202421026247, filed on Mar. 29, 2024, which is hereby incorporated herein by reference in its entirety.

1. An apparatus comprising:
interface circuitry;
first machine-readable instructions; and
at least one processor circuit to be programmed by the first machine-readable instructions to:
access input data that indicates a relationship between components in a diagram, the diagram graphically representing at least a portion of a process control system;
determine coordinate locations associated with the input data within the diagram; and
generate second machine-readable instructions including information corresponding to the coordinate locations, the second machine-readable instructions to cause a change to the diagram based on the input data, the changed diagram indicating the relationship between the components.

2. The apparatus of claim 1, wherein the diagram includes graphical representations of the components, wherein one or more of the at least one processor circuit is to generate a first graphical representation of a first component by:
accessing an input image representing the first component;
identifying the first component as a process control device operable in the process control system;
obtaining identifying information associated with the process control device; and
generating the first graphical representation based on the identifying information.

3. The apparatus of claim 2, wherein the identifying information includes at least one of operating parameters of the process control device, a manufacturer of the process control device, or relational data between the process control device and the components in the process control system.

4. The apparatus of claim 2, wherein the process control device is a first process control device, wherein an image of the first process control device is stored in a database, and wherein the one or more of the at least one processor circuit is to identify the first component as the first process control device by:
comparing the input image to images in the database, the images associated with process control devices, the images having corresponding identifying information for the process control devices; and
when the input image matches the image of the first process control device, associating the first component with the first process control device, the first component and the first process control device sharing the identifying information.

5. The apparatus of claim 4, wherein the input image includes at least one of a hand drawn sketch, a photograph, or a computer generated three-dimensional (3D) model.

6. The apparatus of claim 4, wherein the one or more of the at least one processor circuit is to determine that the input image matches the image of the first process control device based on template matching image processing.

7. The apparatus of claim 1, wherein the diagram is a piping and instrumentation diagram (P&ID) or a process flow diagram (PFD).

8. The apparatus of claim 1, wherein the components include at least one of a process control device, measurement equipment, or control logic circuitry associated with the process control system.

9. The apparatus of claim 1, wherein the diagram is displayed on a user interface associated with a workstation, wherein one or more of the at least one processor circuit is to:
monitor interactions with the user interface, the interactions changing at least one relationship between the components in the diagram; and
detect the input data based on the interactions with the user interface.

10. The apparatus of claim 9, wherein one or more of the at least one processor circuit is to display the changed diagram on the user interface associated with the workstation.

11. At least one non-transitory machine-readable medium comprising first machine-readable instructions to cause at least one processor circuit to at least:
access input data that indicates a relationship between components in a diagram, the diagram graphically representing at least a portion of a process control system;
determine coordinate locations associated with the input data within the diagram; and
generate second machine-readable instructions including information corresponding to the coordinate locations, the second machine-readable instructions to cause a change to the diagram based on the input data, the changed diagram indicating the relationship between the components.

12. The at least one non-transitory machine-readable medium of claim 11, wherein the diagram includes graphical representations of the components, wherein the first machine-readable instructions are to cause one or more of the at least one processor circuit to generate a first graphical representation of a first component by:
accessing an input image representing the first component;
identifying the first component as a process control device operable in the process control system;
obtaining identifying information associated with the process control device; and
generating the first graphical representation based on the identifying information.

13. The at least one non-transitory machine-readable medium of claim 12, wherein the identifying information includes at least one of operating parameters of the process control device, a manufacturer of the process control device, or relational data between the process control device and the components in the process control system.

14. The at least one non-transitory machine-readable medium of claim 12, wherein the process control device is a first process control device, wherein an image of the first process control device is stored in a database, and wherein the first machine-readable instructions are to cause one or more of the at least one processor circuit to identify the first component as the first process control device by:
comparing the input image to images in the database, the images associated with process control devices, the images having corresponding identifying information for the process control devices; and
when the input image matches the image of the first process control device, associating the first component with the first process control device, the first component and the first process control device sharing the identifying information.

15. (canceled)

16. The at least one non-transitory machine-readable medium of claim 14, wherein the first machine-readable instructions are to cause one or more of the at least one processor circuit to determine that the input image matches the image of the first process control device based on template matching image processing.

17. (canceled)

18. (canceled)

19. The at least one non-transitory machine-readable medium of claim 11, wherein the diagram is displayed on a user interface associated with a workstation, wherein the first machine-readable instructions are to cause one or more of the at least one processor circuit to:
monitor interactions with the user interface, the interactions changing at least one relationship between the components in the diagram; and
detect the input data based on the interactions with the user interface.

20. The at least one non-transitory machine-readable medium of claim 19, wherein the first machine-readable instructions are to cause one or more of the at least one processor circuit to display the changed diagram on the user interface associated with the workstation.

21. A method comprising:
accessing, by at least one processor circuit programmed by at least one instruction, input data that indicates a relationship between components in a diagram, the diagram graphically representing at least a portion of a process control system;
determining, by one or more of the at least one processor circuit, coordinate locations associated with the input data within the diagram; and
generating, by one or more of the at least one processor circuit, machine-readable instructions including information corresponding to the coordinate locations, the machine-readable instructions to cause a change to the diagram based on the input data, the changed diagram indicating the relationship between the components.

22. The method of claim 21, wherein the diagram includes graphical representations of the components, the method further including generating a first graphical representation of a first component by:
accessing an input image representing the first component;
identifying the first component as a process control device operable in the process control system;
obtaining identifying information associated with the process control device; and
generating the first graphical representation based on the identifying information.

23. (canceled)

24. The method of claim 22, wherein the process control device is a first process control device, wherein an image of the first process control device is stored in a database, the method further including identifying the first component as the first process control device by:
comparing the input image to images in the database, the images associated with process control devices, the images having corresponding second identifying information for the process control devices; and
when the input image matches the image of the first process control device, associating the first component with the first process control device, the first component and the first process control device sharing the identifying information.

25.-30. (canceled)
